(19) United States
(12) Patent Application Publication
(10) Pub. No.: US 2006/0162840 A1
(43) Pub. Date: Jul. 27, 2006

(54) Method of forming substrates wih visual features

(75) Inventor: Nigel Christopher Abraham, Castle Eden (GB)

Correspondence Address: EDWIN D. SCHINDLER, FIVE HIRSCH AVENUE, P.O. BOX 966, CORAM, NY, 11727-0966, US

(73) Assignee: Fryco Limited, Washington (GB)

(21) Appl. No.: 10/433,887

(22) PCT Filed: Dec. 5, 2001
(86) PCT No.: PCT/GB01/05390

§ 371 Date: Jul. 31, 2003

(30) Foreign Application Priority Data
Dec. 5, 2000 (GB) 0029788.7
Dec. 18, 2000 (GB) 0030880.9

(51) Int. Cl. B32B 37/00; B44C 1/165; B41J 13/12

(52) U.S. Cl. 156/64; 156/230; 156/235; 156/239

(57) ABSTRACT

A method for forming a visual feature on the surface of an article, such as a document or other substrate, which includes the steps of forming data defining the visual feature, and using this data to control a transfer apparatus to transfer discrete elements from at least one foil onto the surface of the article, to form the visual feature. The discrete elements are applied in different densities, for example, numbers per unit area, according to differences in light intensity required to define the visual feature. The discrete elements are, preferably, optically variably reflective and, preferably, also transmissive. The transfer apparatus can be a thermal printer.

The present invention relates to a method of providing substrates with visual images, designs or data, particularly for security or identification purposes.

Since its early days, photography has been used in various ways to identify individuals. For many years, it was common for paper-based photographs to be adhered to documents: this lacked security, because the original photograph could be removed and replaced by another. Various forms of seals and overlays have been used with a view to alleviating this problem, but none have been wholly satisfactory. More recently, dye-sublimation techniques have been used to embed photographs into substrates such as plastics cards, charge cards, plastics driving licences, passports etc; this provides the advantage that the photograph becomes an integral part of the substrate or article but, as the technology has become more commonplace, counterfeiters have become able to make their own versions.

The present invention provides arrangements which alleviate the problems outlined above.

In accordance with the present invention, there is provided a method of forming a visual feature on a surface of a substrate or other article, the method comprising the steps of forming data defining the visual feature, and using said data to control a transfer apparatus to transfer discrete elements from at least one foil onto said surface of the substrate or other article, to form said visual feature.

Also in accordance with the present invention, there is provided a substrate or other article having a surface which carries a multiplicity of discrete elements of foil material, said discrete elements of foil collectively forming a visual feature.

The visual feature may comprise an image of an individual, serving to identify that individual. Thus, a photograph of the individual may be taken, then scanned or otherwise input in data form into a computer, or a digital photograph may be taken and recorded or input in data form into a computer: this computer (or another computer) then uses the data to control the transfer apparatus. The invention is however applicable where the visual feature takes any alternative form, including a design feature or alpha numeric data.

It will be appreciated that the discrete elements (typically dots) are applied in different densities (number of elements per unit of area) in different areas of the substrate surface, according to differences in light intensity required to form the visual feature.

Typically the foil comprises a base or carrier layer and an optical layer (which may comprise a single layer or a number of superimposed layers) provided on one side of the base layer: the optical layer is releaseable from the base layer for adhering to the surface of the intended substrate, For example, the transfer apparatus may comprise a thermal transfer apparatus (e.g. a thermal printer) which applies localised heat to discrete areas of the foil, to release corresponding discrete areas or elements of the optical layer from the base layer and cause those discrete elements to adhere to the surface of the intended substrate.

Preferably the foil comprises a hot stamping foil or a thermal transfer foil (often called a ribbon). The thermal transfer apparatus comprises an array (e.g. a line) of pins and means for heating each pin selectively, independently of the others, to transfer, from the foil, a discrete element of the optical layer, corresponding to the pin which is heated for a given duration of time. Preferably the adjacent pins are thermally insulated from each other. The computer controls the heating of the pins and the transport of the foil and substrate: it will be appreciated that it is possible for every transfer to be unique.

Preferably the optical layer of the foil is reflective and is preferably optically variable, such that it directs reflected light into the eyes of the observer at one or more predetermined angles of view. Preferably the optical layer of the foil comprise a diffraction grating. Thus, in the substrate or article produced by the method in accordance with the invention, the visual feature is visible at one or more predetermined angles of view, but not if the substrate is tilted to other angles of view.

Preferably the optical layer of the foil is transparent or semi-transparent, so that the surface of the substrate or article may carry information or other visual feature which can be seen through the discrete elements of foil applied to that surface. The visual feature provided by the discrete elements of foil thus forms an overlay which is visible at one or more angles of view, whilst the underlying information or visual feature is visible, through the discrete elements of oil and in the spaces around them, at other angles of view.

Embodiments of the present invention will now be described by way of examples only and with reference to the accompanying drawings, in which:

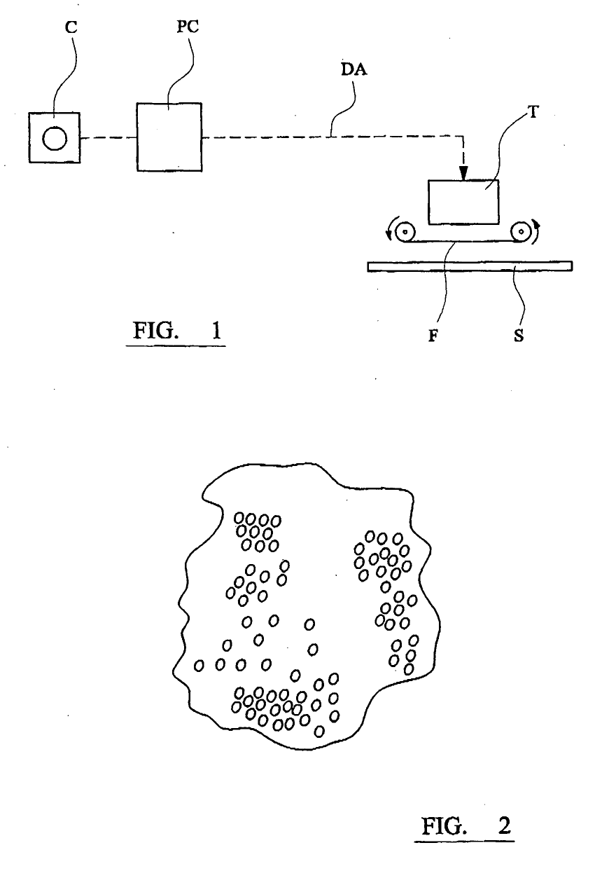

FIG. 1 is a schematic block diagram for use in describing a method, in accordance with the invention, of forming a visual feature on a surface of a substrate;

FIG. 2 is a plan view of a portion of the substrate formed with the visual feature;

FIG. 3 is a diagram showing one way of forming a diffraction grating for the foil used in forming the visual feature;

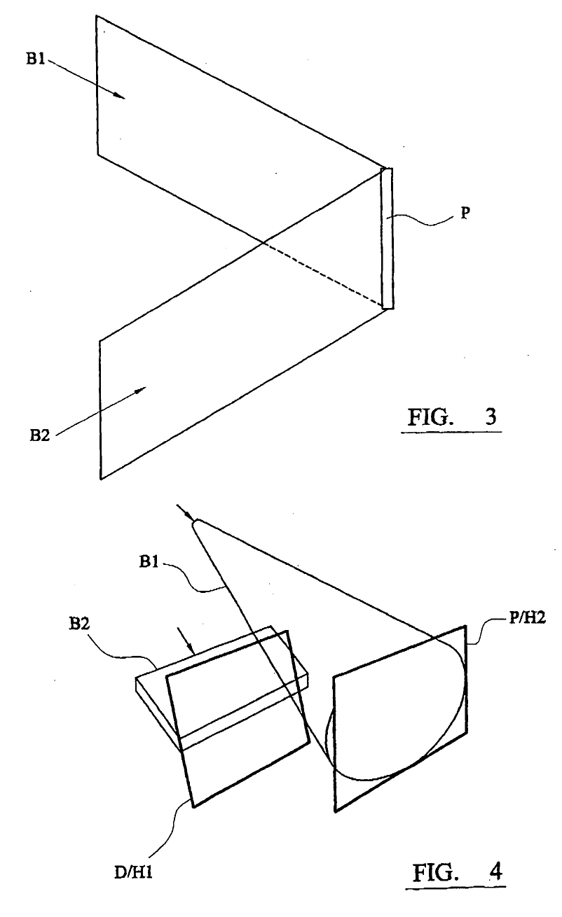

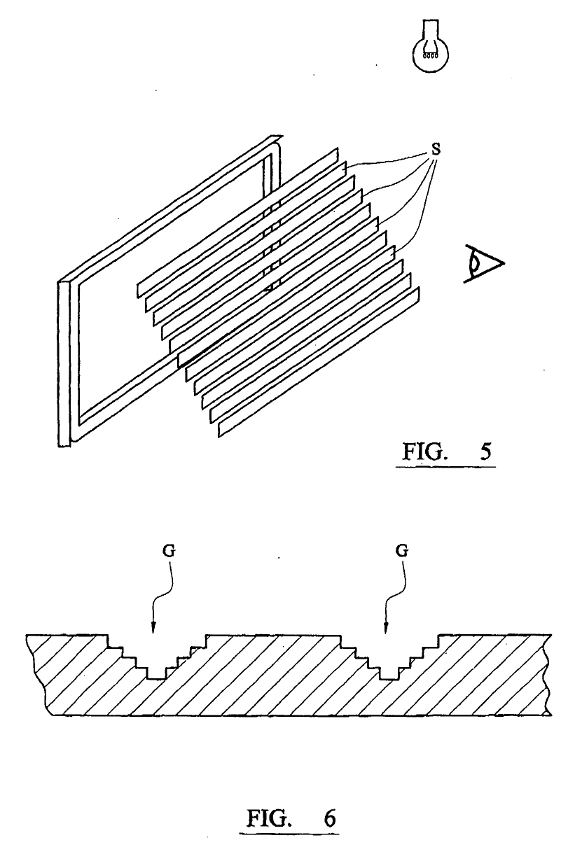

FIGS. 4 and 5 are diagrams showing one way of forming a diffuse hologram for the foil; and

FIG. 6 is a cross-section through a foil formed with surface-relief grooves of stepped-profiles.

Referring to FIG. 1 of the drawings, in a method in accordance with the present invention, initially data DA is formed defining a visual feature, then this data DA is used to control a transfer apparatus T to transfer discrete elements from at least one foil F onto the surface of a substrate or other article S, thus forming the visual feature on that surface.

The data D may be formed using a camera C which takes a photographic image e.g. of an individual. The camera may be a digital camera from which data is passed to a computer PC, or the photograph may be scanned into the computer PC, which outputs the data DA.

As sown in FIG. 2, the transfer apparatus T is controlled by the data DA to transfer elements or dots of the foil F to the substrate S in different densities in different areas of the substrate surface, according to differences in light intensity required to form the visual feature which, in this case, corresponds to the photographic image of an individual.

Typically the foil F comprises an optical layer carried on a base or carrier layer and discrete elements or dots of the optical layer are transferred from the base layer and onto the substrate surface. Typically the transfer process comprises a thermal process, in which heat is applied to discrete elements of the foil to release them from the base layer, and also to activate corresponding discrete areas of an adhesive coating provided over the optical layer; the foil is pressed against the substrate surface to cause the discrete elements of the optical layer to adhere to the substrate and transfer from the base layer. It will be appreciated that the substrate and foil are moved past the application head of the transfer apparatus T, typically step-wise, in synchronism with the successive actuation cycles of the apparatus.

Preferably the optical layer is optically variably reflective and preferably comprises a diffractive surface relief (on the surface which contacts the substrate surface) which provides the variable reflectivity. Preferably the optical layer of the foil is transparent or semi-transparent and the substrate surface may carry information or other visual feature which, at least at one angle of view, can be seen through the discrete elements or dots applied to the substrate surface.

The diffraction grating(s) of the foil may be originated by, for example, a ruling engine, holographically, or by e-beam. The foil may comprise a conventional thermal transfer foil (often known as a ribbon), which normally has a thin polyester base layer (in the order of 3 to 6 μm), or a diffractive hot stamping foil, which generally has a thicker polyester base layer in the order of 12 to 25 μm. Base layers of material other than polyester, such as polypropylene, may be used and it is envisaged that base layers between 6 and 12 μm may be developed.

By way of example, a diffractive (OVD) hot stamping foil may comprise a 12 μm to 25 μm polyester base layer coated with one or more release layers, then coated with one or more lacquer layers, the top layer being embossable or castable: the foil is then embossed or cast with a suitable diffraction pattern, then coated with a thin layer of aluminium (or other dissolvable, reflective metal). To render the foil semi-transparent, the aluminium or other metal layer is then de-metallised, using one of the many techniques known, such as printing a pattern of sodium hydroxide onto the metal layer and washing away the resulting residue. The de-metallising pattern could be achieved using a variety of imagery, the simplest being a fine half tone screen, but many designs could be used such as varying levels of half tone producing a design, such as a logo or coat of arms, with different parts of the design having varying degrees of dot density. Other shapes such as squares, triangles, hexagons etc could also be used. Many different designs could be used if small enough to appear grey(ish) at normal viewing distances. For full, or controlled colour applications, half tone would normally be the most appropriate as the multiple passes of different colour elements would mean the different elements from the different foil-passes would need to match. Larger sizes could be used but would be more distracting. As another variant, the de-metallising pattern may comprise micro-text extending across the design which would only be identified with the use of a suitable magnifier. After the de-metallisation a “tie coat” may be applied to help the adhesion of a subsequent sizing coat to the aluminium or other metal: the foil would then be sized using a suitable dry heat-and-pressure activated adhesive. Normally, the de-metallisation pattern would be either substantially coarser or substantially finer than the pins of the thermal printer.

An alternative method that would achieve a similar effect to half-tone de-metallisation is to use an opaque foil (metallised with aluminium or other reflective metal) and have the thermal transfer machine transfer a mosaic of small points of foil to the substrate, leaving an area around each element free of any transferred foil, thereby allowing the underlying visual feature to be read, whilst the pattern of transferred foil elements still provide an overlay visual feature.

Instead of the foil having a de-metallised metal layer, a high refractive index coating may be applied to the embossed layer of the foil: this would give transparency (ability to view the substrate below) and reflection (ability to view the visual feature) at the same time. A tie coat (to aid adhesion to the high refractive index coating) may be necessary, and a sizing coat, which makes the transfer foil adhere to the substrate, would usually be required. This method may well be more suitable in the majority of situations and would be considerably more suitable for colour applications where multiple passes of foil would normally be necessary.

All types of diffractive (OVD) techniques could be used for the foil, but many will give more suitable results: some of these will be described with reference to the accompanying drawings. A simple arrangement, which provides excellent results, comprise a fine spatial frequency grating, in the order (but not exclusively) of 600-2,000 line pairs per mm, which would give an even spread of spectral colour. Too low a spatial frequency would give a thin band of colour which would make the visual feature difficult to view. Referring to FIG. 3 of the accompanying drawings, one of the easiest ways of producing this grating would be to make a “holographically” produced diffraction grating, which is achieved by exposing two coherent beams B1, B2 (normally from a laser), with a suitable angular spacing apart of these beams, onto a photo-sensitive plate P, such as a photo-resist plate. Such plates (normally glass but not exclusively so) are coated, traditionally dip coated or spun coated, with a resist e.g. from the 1800 series of resists, produced by Shipley Chemicals. These resists are often used in the micro-electronics industry to produce integrated circuits etc.

A variation would be to produce a plain diffuse image, for example provided by a simple diffuse hologram, which could be made in a number of ways. Referring to FIG. 4, one simple method comprises directing a coherent beam B1 onto a photosensitive plate P, and a second beam B2 to a diffuser plate D, some distance in front of the photosensitive plate P, this diffuser D being masked to produce a slit or the beam B2 being a slit-beam. This image would be viewed by flipping over the plate, after it had undergone any necessary processing, and then viewing the slit in space in front of the plate. As the image would be viewed in white light (FIG. 5), many optically-focussed slits S would be produced in space and the viewer would see a diffuse diffractive effect breaking up the spectral range of colours, constituting a breakdown of the light used to view the image.

A clean black and white image may be desirable and this can be achieved by a number of methods. The suitable OVD in this case could be produced by producing a hologram as outlined in the previous paragraph, but this time using two, or preferably three slits, preferably (but not necessarily) angling the diffuser plate using the alpha angle (otherwise known as the achromatic angle) technique, as outlined by Steve Benton of Massachusetts Institute of Technology, and others. This will then overlap colours, in playback, producing an achromatic image. A variation of this method is indicated in FIG. 4, in which the diffuser comprises an H1 (laser transmission) hologram, which is used as a master to expose an H2 (white light transmission) hologram.

Another variation comprises the use of multiple reference beams to make an achromatic image using either the H1/H2 technique recording directly, or using a diffuser and a slit.

A further variation comprises the formation of an open-aperture hologram, as a simple hologram of a diffuse screen, or again an H1 and H2 method could be employed. The H1 to H2 distance is preferably kept relatively small to prevent excessive spectral smearing.

Full colour versions can easily be produced using a number of techniques. One simple form comprises a conventional additive technique, in which the colours are spatially separated giving the primary colours red, green and blue (RGB), which are laid down as small elements in a closely-grouped pattern. Many combinations of RGB elements could be used such as small hexagons, triangles, circles or stripes but, as the resolution of the thermal printers are generally relatively low, the individual “pin” element would probably be equal to one individual colour element. This would normally mean using three separate foils—though different elements giving the three different colours can be provided on a single foil, either in steps down the foil or steps across the foil, each playing back red, green or blue respectively, at one given viewing angle. This can be either of a pure grating or a diffuse OVD. Simpler colour systems could be devised using just two colours which would suffice for many situations. A colour image and/or data may be colour separated, the respective separations would be sent to the matching foil, and a full colour image and/or data would be transferred onto the substrate. The two or three foils could be produced using a two or three slit technique or multiple reference beams, preferably using the alpha angle, as outlined above, but with individual exposures being made to create red, green and blue ribbons, or separate elements of colour spatially separated on the same foil. The substrate may typically (but not necessarily) comprise a security document, e.g. a passport, security pass, driving licence, credit car or charge card. The size of the photograph could vary from a small, barely-visible image, to one covering the whole document. The advantage of the additive technique is that the de-metallised images would have an even density (although high refractive index images would be preferable), but with the disadvantage that spatially separating the colour elements effectively reduces the available resolution, and registration between the three passes is more critical.

An alternative additive technique comprises forming thin red, green or blue diffractive strips repeating across the transfer foil, and then registering the pins on the thermal transfer head to the strips on the foil, giving R, G, B strips of “colours” across the final product. A two colour system may also be developed based on this technique. The technique may also be used with the two or three pass system, running separate foils.

In a further embodiment, subtractive techniques may be used, the secondary colours cyan, magenta and yellow (CMY) being separated from the full colour images and/or data, and fed to diffractive foils that would appear cyan, magenta and yellow respectively, at a given angle. In a similar manner, a CMYK system may be used instead of the CMY system (K being black, black normally being produced by silver foil). As with the additive system, the different “colours” could be provided on the same foil, either running down or across the foil. Subtractive colour works by overlaying the colours on top of each other to produce additional colours. To produce cyan and magenta diffractive (OVD) foils, either as pure gratings or diffuse OVDs, would involve more complex optical set ups than previously outlined. These would involve multiple slits or exposures to give the necessary secondary colours. The disadvantage of this system is there may be variable densities of high refractive index or de-metallisation, which may distract, but with a good quality high refractive index coating this would be negligible. The advantage is it would effectively give a higher resolution than the additive method, and may be less critical on registration between the passes.

Use may be used of the fact that diffractive (OVD) foils have the ability to produce any colour in the spectrum. By laying down one or more colours, in an additive or subtractive fashion, a vast array of colours can be produced using two or more different elements. With this system of “Multiple Diffractive Colour” (MDC), more colours and higher diffraction efficiency is potentially possible, giving the opportunity to provide a bright, full colour image, when the substrate is viewed at a predetermined angle.

In addition to holographic techniques, there are other methods for producing suitable gratings include mechanical methods, which generally involve using a very fine diamond, in a ruling engine, though this generally gives relatively low spatial frequencies. A more satisfactory method is to use an e-beam which exposes a photosensitive plate, then normally developed, and this method can be optimised to produce excellent, high efficiency diffraction gratings. These would often be re-combined using a variety of techniques to produce larger gratings, as it is very expensive to expose large areas. Also direct-write methods, or ablation techniques, using a reasonable high power laser such as Yag laser or Excimer laser, could be used to produce suitable gratings.

In accordance with this invention, the discrete elements may be transferred from the foil, using the transfer apparatus, onto a carrier substrate that is clear and has laminating properties: the substrate is then laminated onto a support substrate such as a security document (including passes, driving licences, passports etc).

In a preferred embodiment, a colour photograph, either digitally-originated or digitally-scanned, is entered into a computer, colour separated into the primary colours RGB and then fed to three transfer heads, each head holding foils relating to the individual colour input, i.e. RGB foils. Each foil would be embossed with a diffraction grating related to the correct angle for the correct colour separation, and would be coated (normally by vacuum deposition or sputtering) with a high refractive index material. The high refractive index material, such a zinc sulphide or titanium dioxide, would stop the subsequent indexing-out of the embossed or cast diffraction gratings. This coating would need to provide a transparent or semi-transparent layer when transferred onto the final substrate, but may have some scatter and/or a colour cast. Sometimes a number of coatings may need to be laid down to achieve maximum diffraction efficiency (brightness or image) in play-back. This would then be coated with one or more layers to give effective adhesion to the final substrate. The transfer apparatus would then transfer discrete elements of the three foils onto the final substrate and give a full colour diffractive (OVD) visual feature when viewed at a predetermined angle.

In accordance with the invention, machine-readable data may be input, instead of a photograph. The finished visual feature could then be read using a suitable reader device. For example, the visual feature may comprise either one-dimensional or two-dimensional bar codes. The visual feature may comprise an image and machine-readable data in combination.

As mentioned above, the foil may comprise an opaque metal layer, such as aluminium, which is then de-metallised over selective areas, using for example, a caustic solution, leaving either a half-tone effect or other shape, lettering etc, which would allow partial transmission (to view the base substrate such as a security document) and partial reflection (to view the diffractive image at a given angle). Instead, a semi-metallised (low density) layer of aluminium, or other suitable reflective metal, may be provided, allowing some reflectivity and some transmission of the final image.

In another embodiment, a black and white photograph, either digitally-originated or digitally-scanned, is entered into a computer. The data is then fed to a thermal transfer head able to take diffractive (OVD) hot stamping foils. This head is loaded with either a diffractive foil of a single high spatial frequency (to give a wide even spread of colour, though this is not necessary for the process) or a specially exposed foil (outlined previously) to give an achromatic (black and white) play-back. The foil would be coated with a high refractive index layer, metallised, de-metallised or lightly metallised, and then coated with one or more layers to give effective adhesion to the intended substrate. The thermal transfer machine would then transfer the discrete elements of the foil onto the intended substrate and give a spectral or achromatic diffractive (OVD) image at a given angle.

In a variation of the above embodiment, machine-readable data would replace the photograph. The finished result could then be read using a suitable reader device. As one example, the machine-readable data may comprise either one dimensional or two dimensional bar codes. Any desired design may be used instead of the photograph or machine-readable data.

In accordance with the invention, production runs may be made with the visual feature remaining the same, after which the visual feature is altered. Where the visual feature comprises both an image and data, either the image or data may stay the same and the other alter. An example could have an image, e.g. a “coat of arms”, which stays the same, and a serial number that alters with every transfer.

Further in accordance with the invention, use may be made of a thermal transfer foil appropriately embossed or cast with diffractive relief patterns. These foils or “ribbons” have generally a much lower base-layer thickness, traditionally in the range of 3-5 μm, but “ribbons” could be developed with base layers in the range of 6-12 μm in thickness. These “ribbons” traditionally have simpler constructions, often combining release and main pigment carrying lacquer (which may be used to hold a diffractive (OVD) relief pattern). High refractive index coatings, traditional metallising, de-metallising or light metallising could potentially be used with this system. Often a silicon layer would be coated onto the polyester base layer to help reduce wear and to stop blocking. This system would have the advantage of being usable with a much greater range, and potentially all, thermal transfer printers, and giving the possibilities of finer resolutions.

In any of the embodiments described herein, the OVD surface relief may, with advantage, be of so-called Aztec form: thus, the opposite sides of the surface relief grooves G are of stepped shape, in the manner shown in FIG. 6 of the accompanying drawings. The successive steps lie in successive planes parallel to the surface of the substrate, such that the steps act collectively in the manner of a volume phase reflection hologram formed in a plain substrate. When illuminated by incident white light, the substrate reflects light of a predetermined colour (determined by the geometry of the steps), which colour remains stable (i.e. there is minimal colour shift) over a range of viewing angles.

1-19. (canceled)

20. A method for forming a visual feature on a surface of a substrate, comprising the steps of:
forming data defining a visual feature; and,
using said data for controlling a transfer apparatus for transferring discrete elements from, at least, one foil onto a surface of a substrate to form said visual feature.

21. The method for forming a visual feature on a surface of a substrate according to claim 20, wherein said discrete elements are applied in different densities on different of said surface, according to differences in light intensity required for defining said visual feature.

22. The method for forming a visual feature on a surface of a substrate according to claim 20, wherein said discrete elements are reflective.

23. The method for forming a visual feature on a surface of a substrate according to claim 22, wherein said discrete elements are reflective.

24. The method for forming a visual feature on a surface of a substrate according to claim 23, wherein said discrete elements are formed with a diffraction grating providing said providing said discrete elements with said optically reflective property.

25. The method for forming a visual feature on a surface of a substrate according to claim 24, wherein said discrete elements are formed with surface relief grooves, wherein opposite sides of each groove of said surface relief grooves comprises a series of steps.

26. The method for forming a visual feature on a surface of a substrate according to claim 20, wherein said discrete elements are transmissive, so that said surface to which said discrete elements are applied is visible through said discrete elements.

27. The method for forming a visual feature on a surface of a substrate according to claim 20, wherein said surface to which said discrete elements are applied carries information which is visible through said discrete elements.

28. The method for forming a visual feature on a surface of a substrate according to claim 20, wherein said surface to which said discrete elements are applied carries information which is visible through spaces between said discrete elements.

29. The method for forming a visual feature on a surface of a substrate according to claim 20, wherein said foil comprises a base layer and an optical layer provided on one side of said base layer, discrete areas of said optical layer being transferred from said base layer to said surface of said substrate form said discrete elements.

30. The method for forming a visual feature on a surface of a substrate according to claim 29, further comprising the step of applying heat to said foil for releasing said discrete areas of said optical layer from said base layer.

31. The method for forming a visual feature on a surface of a substrate according to claim 30, wherein said heat activates an adhesive to adhere said discrete areas of said optical layer to said surface of said substrate.

32. The method for forming a visual feature on a surface of a substrate according to claim 31, wherein said transfer apparatus comprises a thermal transfer apparatus having an array of pins and means for heating selected pins of said array of pins individually. discrete elements are optically variably reflective.

40. The article according to claim 39, wherein said discrete elements are transmissive, so that said surface on which said discrete elements are carried is visible through said discrete elements.

41. The article according to claim 38, wherein said surface on which said discrete elements are carried also carries a feature that is visible through said discrete elements.

42. The article according to claim 38, wherein said surface on which said discrete elements are carried also carries a feature that is visible through spaces between said discrete elements.
